(19) United States
(12) Patent Application Publication
(10) Pub. No.: US 2022/0063202 A1
(43) Pub. Date: Mar. 3, 2022

(54) ADDITIVE MANUFACTURING PARTS

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/420,079

(22) PCT Filed: Jan. 15, 2019
(86) PCT No.: PCT/US2019/013642

§ 371 Date: Jun. 30, 2021

(51) Int. Cl. B29C 64/393; B29C 64/165; B33Y 10/00; B33Y 50/02; B33Y 30/00

(52) U.S. Cl. CPC B29C 64/393; B29C 64/165; B33Y 30/00; B33Y 50/02; B33Y 10/00

(57) ABSTRACT

Some examples include an additive manufacturing system including a processor and a memory to store instructions to cause the processor to ate print data related to a three-dimensional build object. The generated print data comprises defined print data to print a first part and a second part of the object. The defined print data is to orient and position each of the first part and the second part of the object within a build area, the first part including a first mating section, the second part including a second mating section, the first and second mating sections shaped and sized to be matingly coupled to form the build object, to adjacently align the first and second mating sections within the build area, and to separate the aligned first and second mating sections with a gap defined between the first and second parts along the aligned first and second mating sections.

### BACKGROUND

Additive manufacturing machines produce three dimensional (3D) objects by building up layers of material. Some 3D printing techniques are considered additive processes because they involve the application of successive layers of material. Some additive manufacturing machines are commonly referred to as “3D printers”. 3D printers and other additive manufacturing machines make it possible to convert a CAD (computer aided design) model of other digital representation of an object into the physical object.

### BRIEF DESCRIPTION OF THE DRAWINGS

FIG. 1 is a block diagram of an example additive manufacturing system in accordance with aspects of the present disclosure.

FIG. 2 is a schematic diagram of an example additive manufacturing system in accordance with aspects of the present disclosure.

FIGS. 3A-3D are schematic diagrams of formed layers of three-dimensional build objects including under-fused areas in accordance with aspects of the present disclosure.

FIG. 4 is a schematic diagram of an example of a three-dimensional build object formed of parts with consistent geometric errors formed in accordance with aspects of the present disclosure.

FIG. 5 is a flow diagram of an example additive manufacturing method in accordance with aspects of the present disclosure.

FIG. 6 is a block diagram of an example non-transitory computer readable medium comprising a set of instructions executable by a processor in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Additive manufacturing processes can include multi-jet fusion (MJF), selective laser sintering (SLS), and 3D binder jetting, for example. In some additive 3D manufacturing processes, such as in a multi-jet fusion fabricating process, as well as in other types of fabricating processes, heat is applied to build material particles located in selected areas such that those selectively located build material particles melt and fuse together to form a section of a 3D fabricated part. Some of the applied heat can bleed out to other build material particles that are outside of, e.g., adjacent to, the build material particles located in the selected areas. This “thermal bleeding” can cause unintended build issues in sections of 3D build parts formed from other build material particles that receive the excess heat, which can result in poor quality parts.

3D objects can be formed of multiple parts that are assembled subsequent to the 3D fabrication process in order to form the object, instead of being printed as a single part forming the complete object. The object can be formed from multiple distinct parts concurrently formed during a single 3D build operation. Geometric accuracy of the 3D printed parts can vary depending on the part sizes, geometries, packing orientations and positions, etc. When the parts are assembled together, the geometric errors can become more significant due to the tolerance accumulation and lead to low quality assemblies.

The parts often have inconsistent geometric accuracies caused by the 3D fabrication process, such as thermal bleed, and the resulting assemblies often have significant assembly errors, such as disconnection, surface discontinuation and other quality issues. For instance, those build material particles that receive more heat than intended may become over-fused. When parts are to be later assembled together to form the object, the parts may not fit together in the desired manner due to undesired build quality issues.

The present disclosure provides systems and methods for producing three dimensional objects with improved accuracy and fit between assembled parts forming a 3D object. Thermal energy management concerns regarding the parts can be addressed while an arrangement of the parts may be determined that can result in an optimized final accuracy and fit between the parts to form the object and high quality fabrication of the parts. The arrangement of parts during the build process can include the placements and orientations of the parts within the build area to compensate for thermal energy management concerns, such as thermal energy effects (e.g., thermal bleed) between the parts. Parts can be fabricated jointly or concurrently within a build area of an additive manufacturing device. In accordance with aspects of the present disclosure, the arrangement of the parts can be determined to provide under-fused areas selectively connecting sections of the parts to improve the accuracy of the fit of the parts. The section of the parts can have similar formation patterns including accuracies even when there are large geometric errors, or deformities.

During the 3D fabrication process, an arrangement of parts within the build area can include very small packing distance (e.g., gap) between parts to be assembled. The gap between the parts can be under-fused so that the under-fused part can physically bond the parts together during the 3D fabrication process. As a result, the parts are able to distort in the same direction and corresponding form or shape of deformation, such as warpage, when the parts are fused. Therefore, the parts are configured to fit correspondingly with each other in the assembled state. In addition, because the parts are printed continuously as one single part including fully fused and under-fused areas, the size accuracy is consistent along each of the contact surfaces of the adjoined parts. The parts in the assembly can include similar, or complimentary, deformities and accuracies, providing for a complimentary fit to each other in the assembly, as discussed further below.

The under-fused part can be easily separated from the fused parts subsequent to the 3D fabrication process in order that the parts can be assembled together. The separation can be easily accomplished due to the low mechanical strength of the under-fused build material. The under-fused part can provide an ease of cleaning of residual build material from the parts.

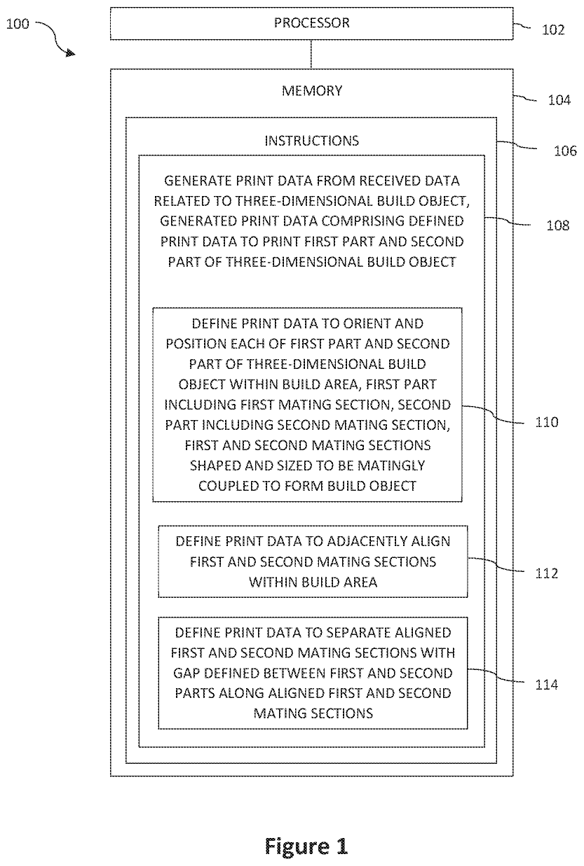

FIG. 1 is a block diagram of an example additive manufacturing system 100 in accordance with aspects of the present disclosure. Additive manufacturing system 100 includes a processor 102 and a memory 104. Memory 102 and processor 104 can be in communication with a data store (not shown) that can include data pertaining to a 3D build object to be formed by the additive manufacturing system 100. Memory 102 and/or processor 104 can receive data defining an objected to be printed including, for example, 3D object model data and 3D parts model data. In one example, the 3D object model data includes data related to the build object size, shape, position, orientation, color, etc. The data can be received from Computer Aided Design (CAD) systems or other electronic systems useful in the creation of a three-dimensional build object. Processor 104 can manipulate and transform the received and/or stored data to generate print data. The generated print data can include defined print data related to the build object and part size(s), shape, position, orientation, color, conductivity, for example. Processor 104 employs print data derived from the 3D build object model data of the 3D build object to be formed in order to control elements of the additive manufacturing system 100 to selectively deliver/apply build material, printing agent, and energy.

Processor 102 can control operations of additive manufacturing system 100 and can be a semiconductor-based microprocessor, a central processing unit (CPU), and application specific integrated circuit (ASIC), field-programmable gate array (FPGA), and/or other hardware device. Memory 104 can store data, programs, instructions, or any other machine readable data that can be utilized to operate the additive manufacturing system 100. Memory 104 can store computer readable instructions 106 that processor 102 can process, or execute. Memory 102 can be an electronic, magnetic, optical, or other physical storage device that contains or stores executable instructions 106. Memory 102 can be, for example, Random Access Memory (RAM), an Electrically Erasable Programmable Read-Only Memory (EEPROM), a storage device, an optical disc, etc. Memory 102 can be a non-transitory machine-readable storage medium.

Instructions 106 can include a set of instructions 108-114. Instruction 108 is to generate print data from received data related to a three-dimensional build object. The generated print data can include defining print data to print a first part and a second part of the three-dimensional build object. Instruction 110 to generate print data includes defining print data to orient and position each of the first part and the second part of the three-dimensional build object within a build area, the first part including a first mating section, the second part including a second mating section, the first and second mating sections shaped and sized to be matingly coupled to form the build object. Instruction 112 to generate print data includes defining print data to adjacently align the first and second mating sections within the build area. Instruction 114 to generate print data includes defining print data to separate the aligned first and second mating sections with a gap defined between the first and second parts along the aligned first and second mating sections.

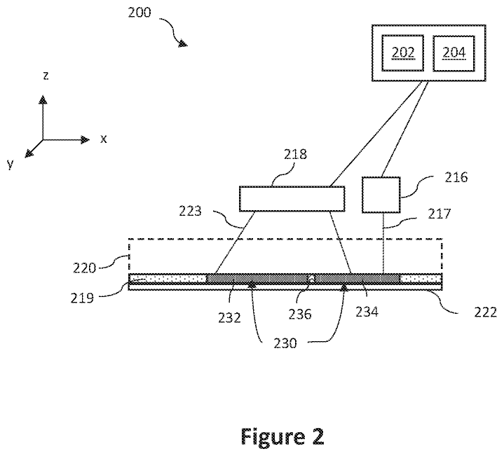

FIG. 2 is a schematic diagram of an example additive manufacturing system 200 in accordance with aspects of the present disclosure. The example additive manufacturing system 200 is one example of an additive manufacturing system and other examples can of additive manufacturing systems can include such systems as Fused Filament, stereolithography (SLA), selective laser sintering (SLS), selective laser melting (SLM), and 3D binder jetting, for example. Additive manufacturing system 200 includes a processor 202, a memory 204, a printhead 216, and an energy source 218. Processor 202 and memory 204 are similar to processor 102 and 104 described above. Memory 204 stores instructions to generate print data from received data related to a three-dimensional build object. Processor 202 can generate defined print data, which may be represented as physical (electronic) quantities, in order to cause printhead 216 and energy source 218 to create the 3D build object, as described further below.

Printhead 216 is adapted to deposit liquid agents, as indicated by line 217, such as a printing agent onto a build material layer 219 based on generated print data. Printhead 216 selectively deposits printing agent based on the print data. Processor 214 can transform received data of the build object to generate print data including locations and saturation levels of the printing agent dispensed from printhead 216. Printhead 216 can include a single inkjet pen, for example, or multiple inkjet pens. In one example, printhead 216 includes at least one fusing agent pen and at least one detailing agent pen. In some examples, the same printhead can be employed to deposit both printing agent and detailing agent. In other examples, separate printheads are used for each of printing agent and detailing agent. Printhead 216 can be carried on a moving carriage system to move across a build area 220.

The printing agent can be an energy absorbing liquid that can be applied to build material 219, for example. According to one example, a suitable printing, or fusing, agent may be an ink-type formulation comprising carbon black, such as, for example, the fusing agent formulation commercially known as V1Q60Q “HP fusing agent” available from HP Inc. In one example, the printing agent can be fusable at certain saturation levels (e.g., contone levels) and un-fusable or under-fusable at dosages, or saturation levels (e.g., contone levels) lower than useful to provide full fusablity due to the carbon black or other suitable agent included in the printing agent. More than one type of suitable fusing and detailing agents can be employed.

Printing agent can be applied to build material. Build material can be deposited onto a build surface 222 to form build material layer 219. Build surface can be a surface of a platen or underlying build layers of build material on a platen within a build chamber, for example. A build material supply device (not shown) can supply and deposit successive layers of build material to form a build volume within a build area 220. Build material supply device can be moved across build surface within the build area on a carriage, for example. Build material can be a powder polymer-based type of build material. Build material can include polymer, ceramic, metal, or composite powders (and powder-like materials), for example. Polymeric build material can be crystalline or semi-crystalline polymers in powder form. In some examples, the powder may be formed from, or may include, short fibres that may, for example, have been cut into short lengths from long strands or threads of material. According to one example, a suitable build material may be PA12 build material commercially known as V1R10A “HP PA12” available from HP Inc.

Build area 220 can be defined as a three-dimensional space in which the additive manufacturing system 200 can fabricate, produce, or otherwise generate a three-dimensional build object 230, including a first part 232 and a second part 234. Build area 220 can occupy a three-dimensional space on top of a build area surface, such as a build area platform or platen 222. In one example, the width and length (x and y directions) of build area 220 can be the width and the length of build area platform and the height of build area 220 can be the extent to which build area platform can be moved in the z direction. Although not shown, an actuator, such as a piston, can control the vertical position of build area platform.

Energy source 218 can apply fusing energy, indicated by lines 223, to build material and printing agent on the build area surface 222 in order to form the object layer. Build material and printing agent can be exposed to energy source 218, such as a thermal energy source, for fusing. Energy source 218 can include a heating source to heat build material layer and a fusing source to fuse the printing agent with the build material in locations that the printing agent is selectively applied. The printing agent can facilitate fusing of the build material, where printed or applied, by absorbing energy from the fusing energy source and converting the energy to heat to raise the temperature of the build material above the melting or softening point. Energy source 218 can generate heat that is absorbed by fusing energy absorbing components of the printing agent to sinter, melt, fuse, or otherwise coalesce the patterned build material. In some examples, energy source 218 can apply a heating energy, to heat the build material to a pre-fusing temperature, and a fusing energy, to fuse the build material where the printing agent has been applied. Thermal, infrared, or ultraviolet energy can be used, for example, to heat and fuse the material. Energy source 218 can be mounted to the carriage system and moved across build surface 222 to apply the heating and fusing energies to the printing agent patterned build material.

Processor 202 can generate defined print data in order to cause printhead 216 and energy source 218 to create the build object 230 including first part 232 and second part 234 separated by an under-fused area 236, or bridge portion defined by a gap between first part 232 and second part 234 of build object 230. Three-dimensional build object 230, including a first part 232 and a second part 234. In accordance with aspects of the present disclosure, the arrangement of parts 232, 234 can include very small packing distances, or gaps, between parts 232, 234 to form under-fused area 236 during the 3D printing process. In some examples, the packing distance is in the range of 10 μ-1 mm. In some examples, the packing distance can be 100-200 μm. Factors in determining the size of the packing distance can include the build material particle size, contone level of the printing agent, and the desired strength of the under-fused area 236 formed within the gap. The small distances, or gaps, between the parts can be under-fused in order to physically bond parts 232, 234 together during the printing process. Under-fused area 236, formed at the gap, provides an under-fused bridge or connection that applies complimentary forces to such that formations, including build deformities, can be formed on the sections of parts 232, 234 connected to, or adjacent to, under-fused area 236, as described further below.

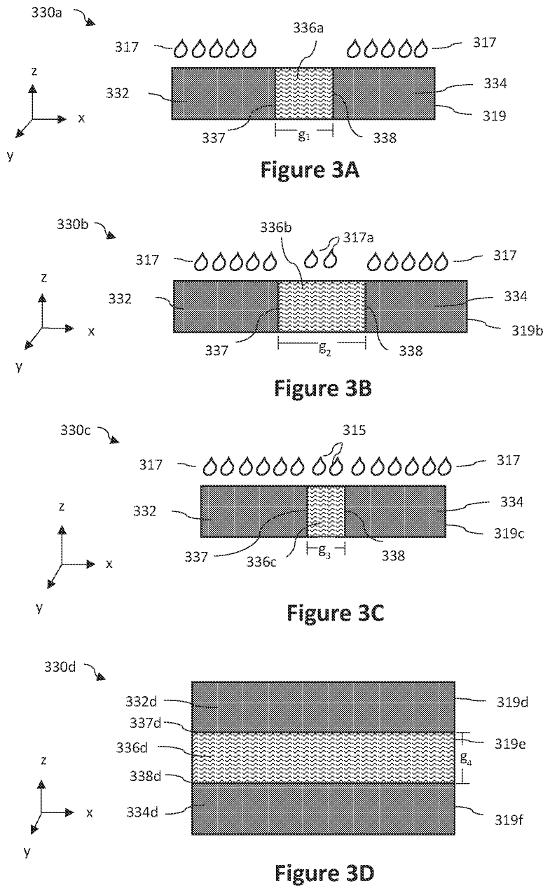

FIGS. 3A-3D are schematic diagrams of formed layers of three-dimensional build objects 330a-330d including under-fused areas 336a-336d disposed between first parts 332-332d and second parts 334-334d in accordance with aspects of the present disclosure. First part 332-332d include a first mating section 337-337d, or mating surface, and second part 334-334d include a second mating section 338-338d, or mating surface. First and second mating sections 337, 338 are oriented and aligned across gap distance g₁-g₄. In some examples, first and second mating sections 337, 338 are aligned along two directions perpendicular from the gap distance. For example, in FIGS. 3A-3C, first and second mating sections 337, 338 can be aligned along the z and y axes and the gap distance g₁-g₃ can extend along the x axis. In another example, as illustrated in FIG. 3D, first and second mating sections 337d, 338d can be aligned along the x and y axes and the gap distance g₄ can extend along the z axis. Other orientations and alignments are also acceptable. In some examples, under-fused areas 336a-336d can structurally connect fused first part 332-332d to fused second part 334-334d during the print process forming build object 330a, as discussed further below. The degree of fusion of the under-fused area 336a-336d disposed between fused parts 332, 334 can be controlled by the size of gap distance. Gap distance g₁-g₄ is sized to form under-fused areas 336a-336d.

FIG. 3A illustrates under-fused area 336a formed between first part 332 and second part 334 across a gap distance g₁ within build layer 319a. Print, or fusing, agent 317 is applied accordance with the print data generated of the build object 330a to form fused first and second parts 332, 334. In this example, the print data includes a gap g₁, or space, between the first and second parts 332, 334 wherein fusion agent 317 is not applied to the build material. In this example, under-fused area 336a is solidified by the heat (e.g., thermal bleed) from the fully fused first and second parts 332, 334. In one example, thermal bleed across the entire gap distance g₁ between first and second parts 332, 334 can result from the fusing energy applied to build layer 319a to form under-fused area 336a.

In another example, as illustrated in FIG. 3B, a second printing agent 317a can be applied (e.g., dispensed by the printhead) to the build material within gap distance g₂ disposed between first and second parts 332, 334. Second printing agent 317a can have a lower saturation level, or contone level, than printing agent 317 applied to form first and second parts 332, 334. Second printing agent 317a applied at the gap to form under-fused area 336b can provide material properties different than the material properties of fused first and second parts 332, 334. For example, the under-fused area 336b can be more brittle or porous than first and second parts 332, 334. Gap distance g₂ forming under-fused area 336b can be larger, or greater than, gap distance g1 forming under-fused area 336a. Different contone levels can be employed both within a respective layer 339b (e.g., FIG. 2B) and across a section of layers 319d-319f (e.g., FIG. 3D), depending on the desired properties of the under-fused area 336 and the final desired properties of the fused parts 332, 334 of the build object 330.

In another example, as illustrated in FIG. 3C, a detailing agent 315 can be applied (e.g., dispensed by the printhead) to build material layer 319c within gap distance g₃ between first and second parts 332, 334 and printing agent 317 applied to build material layer 319c at first and second parts 332, 334. Detailing agent 315 can lower a temperature to reduce fusion of the build material where applied. Detailing agent 315 can limit the thermal bleed from first and second parts 332, 334 and provide for gap distance g₃ that is smaller, or less than, gap distance g₁. With reference to FIG. 3D, under-fused area 336d is formed within build layer 319e disposed between build layers 319d and 319f forming first and second parts 332d and 334d, respectively. In one example, as illustrated, gap distance g₄ is substantially equivalent to a thickness of build layer 319e. In other examples, gap distance g₄ can be a multiple of the build layer 319e thickness.

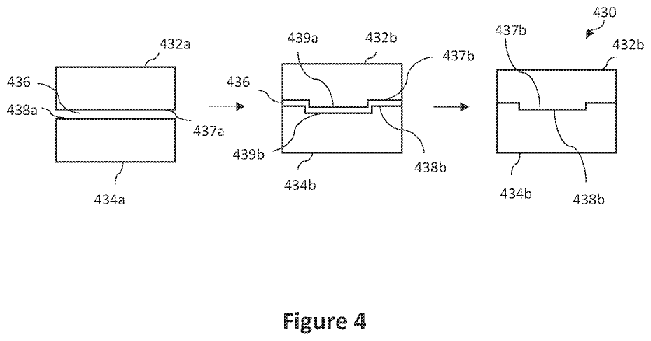

FIG. 4 is a schematic diagram of an example build process of a three-dimensional build object 430 formed of parts with consistent geometric errors, or deformities, formed in accordance with aspects of the present disclosure. A first part 432a and a second part 434a are generated and defined from the received data from the CAD or other electric file to define by the processor. First part 432a includes a first mating section 436a and the second part 434a includes a second mating section 438a. First and second mating sections 436a, 438a can include full or partial mating surfaces of the first and second parts 432a, 434a. First and second parts 432a, 434a are oriented and positioned to include the first and second mating sections 436a, 438a aligned with one another within the build area to be separated by a gap 436. In one example, first and second parts 432a, 434a are oriented within the build area with a 0.5 mm wide gap 436 between first mating section 436a of and second mating section 438a. As discussed above with respect to FIGS. 3A-3D, build material within gap 436 can form an under-fused area 436b that can physically bond first and second parts 432, 434 together during the 3D fabrication process. As illustrated, during the 3D build process, distortions 439a, 439b can occur, in particular along the first and second mating sections 436b, 438b during the fusing process. As a result, first and second mating sections 436b, 438b of first and second parts 432b, 434b can distort in the same direction and with corresponding form or shape of deformation 439a, 439b, such as warpage, when first and second parts 432b, 434b are fused. Distortions, or deformities, 439a, 439b can be reciprocally or inversely related across under-fused area 436. Deformities 439a, 439b are formed independent of the print data.

Under-fused area 436 forms a temporary and separable bond between first and second fused parts 432b, 434b. After the 3D fabrication, under-fused area 436 between first and second parts 432b, 434b is separated from first and second parts 432b, 434b for post-processing. As illustrated with assembled build object 430, first and second mating sections 436b, 438b of first and second parts 432b, 434b are configured to fit correspondingly with and contact each other, including deformities 439a, 439b caused by the fusing process, in the assembled state of build object 430. In accordance with aspects of the present disclosure, with first and second parts 432, 434 printed continuously as one single part (i.e., joined together by under-fused area 436) along first and second mating sections 436, 438, first and second parts 432, 434 can include similar, or complimentary, deformities and accuracies, providing for a complimentary fit to each other in the final assembly of build object 430. It is understood that first and second parts 432, 434 are used for illustrative purposes and that more than two parts can be similarly formed and assembled to form a build object in accordance with aspects of the present disclosure.

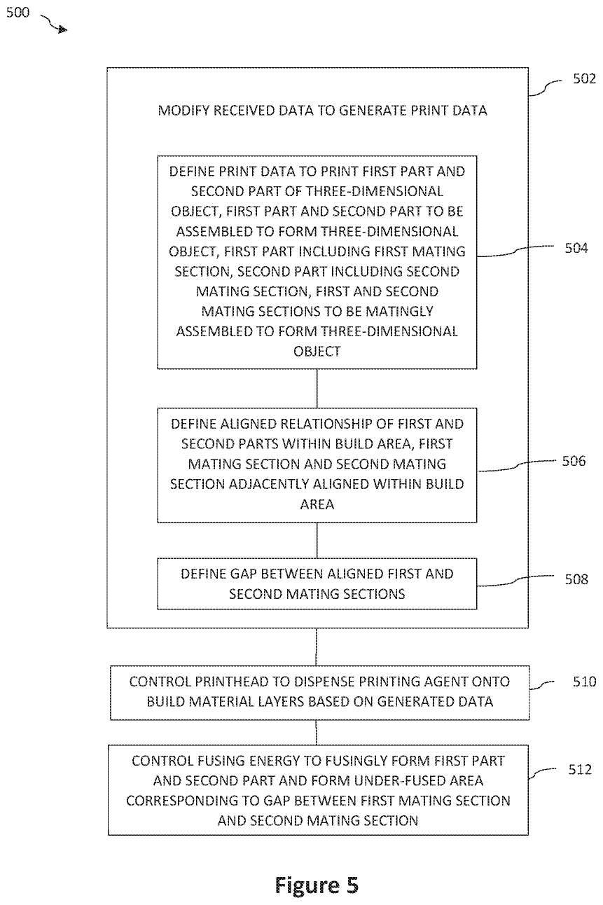

FIG. 5 is a flow diagram of an example additive manufacturing method 500 in accordance with aspects of the present disclosure. At 502, received data is modified to generate print data. At 504, print data is defined to print a first part and a second part of the three-dimensional object. The first part and the second part are to be assembled to form the three-dimensional object. The first part includes a first mating section, the second part includes a second mating section. The first and second mating sections are to be matingly assembled to form the three-dimensional object. At 506, an aligned relationship of the first and second parts within the build area is defined. The first mating section and second mating section are adjacently aligned within the build area. At 508, a gap is defined between the aligned first and second mating sections. At 510, a printhead is controlled to dispense a printing agent onto build material layers based on the generated data. At 512, a fusing energy is controlled to fusingly form the first part and the second part and form an under-fused area corresponding to the gap between the first mating section and the second mating section.

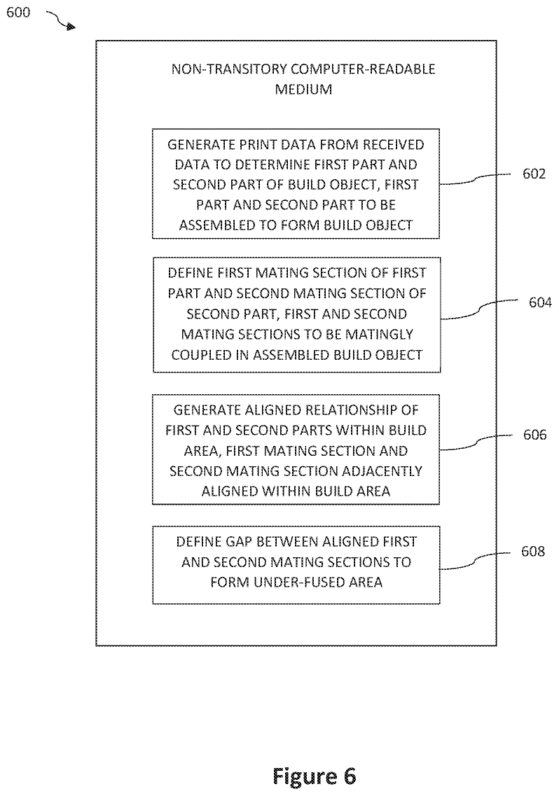

FIG. 6 is a block diagram of an example non-transitory computer readable medium 600 in accordance with aspects of the present disclosure. In one example, non-transitory computer-readable storage medium 600 is included in the memory of the additive manufacturing system and includes a set of instructions 602-608 executable by the processor. Instruction 602 can generate print data from received data to determine a first part and a second part of a build object, the first part and the second part to be assembled to form the build object. Instruction 604 can define a first mating section of the first part and a second mating section of the second part, the first and second mating sections to be matingly coupled in the assembled build object. Instruction 606 can generate an aligned relationship of the first and second parts within the build area, the first mating section and second mating section adjacently aligned within the build area. Instruction 608 can define a gap between the aligned first and second mating sections to form an under-fused area. Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An additive manufacturing system comprising:
a processor; and
a memory to store instructions to cause the processor to:
generate print data from received data related to a three-dimensional build object, the generated print data comprising defined print data to print a first part and a second part of the three-dimensional build object comprising:
defined print data to orient and position each of the first part and the second part of the three-dimensional build object within a build area, the first part including a first mating section, the second part including a second mating section, the first and second mating sections shaped and sized to be matingly coupled to form the build object,
defined print data to adjacently align the first and second mating sections within the build area, and
defined print data to separate the aligned first and second mating sections with a gap defined between the first and second parts along the aligned first and second mating sections.

2. The additive manufacturing system of claim 1, comprising:
a printhead to dispense a printing agent onto build material layers based on the generated data; and
an energy source to apply fusing energy to fusingly form the first part and the second part and form an under-fused area corresponding to the gap between the first mating section and the second mating section.

3. The additive manufacturing system of claim 1, wherein the gap defined between the first and second parts along the aligned first and second mating sections is to form an under-fused structural connection between the fused first part to the fused second part.

4. The additive manufacturing system of claim 1, wherein the gap defined between the first and second parts along the aligned first and second mating sections is to form an under-fused area connecting the first part with the second part to reciprocally correspond build distortions along the first and second mating sections.

5. A method of producing a three-dimensional object comprising:
modifying a received data to generate print data, comprising:
defining print data to print a first part and a second part of the three-dimensional object, the first part and the second part to be assembled to form the three-dimensional object, the first part including a first mating section, the second part including a second mating section, the first and second mating sections to be matingly assembled to form the three-dimensional object,
defining an aligned relationship of the first and second parts within the build area, the first mating section and the second mating section adjacently aligned within the build area, and
defining a gap between the aligned first and second mating sections;
controlling a printhead to dispense a printing agent onto build material layers based on the generated data; and
controlling a fusing energy to fusingly form the first part and the second part and form an under-fused area corresponding to the gap between the first mating section and the second mating section.

6. The method of claim 5, wherein the under-fused area forms a separable connection between the first part and the second part.

7. The method of claim 5, wherein the under-fused area is disposed between build layers of the first and second parts.

8. The method of claim 5, wherein the under-fused area is disposed within build layers of the first and second parts.

9. The method of claim 5, wherein the first mating section includes a first print deformity matingly corresponding to a second print deformity of the second mating section disposed across the under-fused area.

10. The method of claim 9, wherein the first print deformity and the second print deformity are formed to mate independent of the print data.

11. The method of claim 5, comprising:
separating the under-fused area from the first and second parts.

12. The method of claim 11, comprising:
assembling the first part with the second part to form the build object, wherein the first and second mating sections are aligned and coupled with the first and second print deformities matingly fitted together.

13. A non-transitory computer-readable data storage medium storing instructions executable by a processor to:
generate print data from received data to determine a first part and a second part of a build object, the first part and the second part to be assembled to form the build object,
define a first mating section of the first part and a second mating section of the second part, the first and second mating sections to be matingly coupled in the assembled build object;
generate an aligned relationship of the first and second parts within the build area, the first mating section and the second mating section adjacently aligned within the build area; and
define a gap between the aligned first and second mating sections to form an under-fused area.

14. The non-transitory computer-readable data storage medium storing instructions executable by a processor of claim 13 to cause a print device to dispense a detailing agent at the gap.

15. The non-transitory computer-readable data storage medium storing instructions executable by a processor of claim 13 to cause a print device to dispense a first fusing agent at the first and second parts and a second fusing agent at the gap.
